(19) United States
(12) Patent Application Publication
(10) Pub. No.: US 2023/0288599 A1
(43) Pub. Date: Sep. 14, 2023

(54) DEVICE AND METHOD FOR GEO-ELECTRIC EXTRACTION UNDER WATER LAYER COVERAGE

(71) Applicant: GUILIN UNIVERSITY OF TECHNOLOGY, Guilin (CN)

(72) Inventors: Fei OUYANG, Guilin (CN); Xianrong LUO, Guilin (CN); Meilan WEN, Guilin (CN); Ruiling TONG, Guilin (CN); Wen GAO, Guilin (CN); Jiangtao SHAN, Guilin (CN); Baohua WANG, Guilin (CN); Yarong LIU, Guilin (CN)

(73) Assignee: GUILIN UNIVERSITY OF TECHNOLOGY, Guilin (CN)

(21) Appl. No.: 17/908,230

(22) PCT Filed: Apr. 30, 2021
(86) PCT No.: PCT/CN2021/091297

§ 371 Date: Aug. 30, 2022

(30) Foreign Application Priority Data
Apr. 8, 2021 (CN) 202110379302.4

(51) Int. Cl. G01V 3/08

(52) U.S. Cl. CPC G01V 3/082

(57) ABSTRACT

A device and method for geo-electric extraction under water layer coverage are provided. The device includes auxiliary tubes, outer casings, main tubes, mud extractors, encapsulated extraction electrodes and a fixing ferrule assembly, where the auxiliary tubes each have one end open and the other end closed; the outer casings each have one end open and the other end detachably connected to a top cover; an inner diameter of each of the outer casings is larger than an outer diameter of each of the auxiliary tubes; an outer diameter of each of the main tubes is smaller than the inner diameter of each of the outer casings; the mud extractors each include an inner rod, an outer rod and a bottom plate; the outer rod is sleeved outside the inner rod; the inner rod has one end provided with a dredging wheel and the other end provided with a handle.

### CROSS REFERENCE TO THE RELATED APPLICATIONS

This application is the national phase entry of International Application No. PCT/CN2021/091297, filed on Apr. 30, 2021, which is based upon and claims priority to Chinese Patent Application No. 202110379302.4, filed on Apr. 8, 2021, the entire contents of which are incorporated herein by reference.

### TECHNICAL FIELD

The present disclosure belongs to the technical field of mineral exploration, and specifically relates to a device and method for geo-electric extraction under water layer coverage.

### BACKGROUND

Deep concealed mineral exploration is the main task of mineral exploration in the world, and penetrating exploration is an important development direction of current mineral exploration methods. Geo-electric extraction is a method by extracting trace elements in soil through electric field excitation, where the device used includes two parts: a power supply and an extraction electrode.

However, the prior art has the following problems:

1) The prior art is not suitable for special topography, such as paddy fields, swamps, rivers and other places with water coverage. In the case of obvious accumulation of water on the surface, the water will bring the trace elements in the topsoil layer shown in FIG. 12 into the extraction electrode, which will seriously affect the extraction results. The trace elements extracted by using the geo-electric extraction technology mainly come from deep underground. These trace elements are accumulated over a long period of time (sometimes up to millions of years) under geological action, so their content is very low (below ppm level). The composition and content of trace elements in the topsoil layer are quite different from those in the elurium, and they are susceptible to human and other factors, especially heavy metal contamination, thereby leading to a significant impact on the extraction results. Therefore, if there is significant accumulation of water on the surface, it is impossible to carry out extraction without changing the extraction location.

2) The prior art has the problem of loss of the extraction liquid. The extraction liquid is poured into the open space around the extraction electrode in the soil, and it will spread around over time. It has been found that there is an unobvious loss of the extraction liquid within 24 hour, and a significant loss of the extraction liquid over 24 hour, especially in dry, sandy soil. The loss of the extraction liquid will affect the conductivity of the soil and increase the resistivity between the two extraction electrodes, thereby affecting the extraction effect.

3) The existing operation procedure destroys the original structure of the soil, and there is potential human impact. Since a 50 cm deep pit is dug to bury the extraction electrode, the soil around the extraction electrode is actually disturbed, and it is the result of artificial backfilling. This destroys the original soil structure, increases the porosity, and changes the soil conductivity, resulting in a human impact on the extraction result.

### SUMMARY

To solve the above technical problems, the present disclosure adopts the following technical solutions:

A device for geo-electric extraction under water layer coverage includes auxiliary tubes, outer casings, main tubes, mud extractors, encapsulated extraction electrodes and a fixing ferrule assembly, where
the auxiliary tubes each have one end open and the other end closed;
the outer casings each have one end open, and the other end detachably connected to a top cover provided with a central hole; and an inner diameter of each of the outer casings is larger than an outer diameter of each of the auxiliary tubes;
an outer diameter of each of the main tubes is smaller than the inner diameter of each of the outer casings;
the mud extractors each include an inner rod, an outer rod and a bottom plate; the outer rod is rotatably sleeved outside the inner rod; the inner rod has one end provided with a dredging wheel and the other end provided with a handle; the bottom plate includes a first bottom plate and a second bottom plate that are arranged up and down; the first bottom plate and the second bottom plate each are provided with a plurality of mud holes, and the mud holes of the first bottom plate are staggered with the mud holes of the second bottom plate; the first bottom plate and the second bottom plate are fitted and arranged adjacent to one end of the dredging wheel; the first bottom plate is fixedly connected to the outer rod, and the second bottom plate is fixedly connected to the inner rod; and diameters of the dredging wheel, the first bottom plate and the second bottom plate are adapted to the inner diameter of each of the outer casings;
the encapsulated extraction electrodes each include a housing; the housing includes an upper part and a lower part; the upper part of the housing is a closed structure, and the lower part of the housing is an open structure; a bottom end of the lower part of the housing is provided with a tray; and the tray is connected to the upper part of the housing through posts;
a liquid storage bottle for storing an extraction liquid is provided in the upper part of the housing; a conventional electrode is provided between the tray and the upper part of the housing; a drip tube with a valve is provided between the liquid storage bottle and the conventional electrode; and the drip tube delivers the extraction liquid in the liquid storage bottle to the conventional electrode; and
the fixing ferrule assembly includes a power supply box and two ferrules; the two ferrules are respectively provided at two ends of the power supply box; the ferrules each are connected to the power supply box at an adjustable distance; and the ferrules each are matched with a lifting rod.

Further, the first bottom plate and the second bottom plate may be circular, and each may be provided with three fan-shaped mud holes that may be evenly distributed; and generatrices of the fan-shaped mud holes may be radiated outward from a circular center.

Further, an upper surface of the housing may be provided with a first screw, which may be matched with the lifting rod for lifting and lowering the housing.

Further, the liquid storage bottle and the conventional electrode may be fixedly connected together through a connector; the connector may include a shell; one end of the shell may be provided with an opening, which may be provided therein with a second screw for fixing the liquid storage bottle; the other end of the shell may be provided with a closing bottom plate; the closing bottom plate may be provided with an electrical clip that may fix the conventional electrode; and specifically, the electrical clip may hold a carbon rod in the conventional electrode.

Further, a connecting rod and a threaded sleeve may be arranged between each of the ferrules and the power supply box; one end of the threaded sleeve may be fixedly connected to the power supply box, and the other end thereof may be threadedly connected to one end of the connecting rod; and the other end of the connecting rod may be fixedly connected to each of the ferrules.

A method for geo-electric extraction under water layer coverage uses the device for geo-electric extraction under water layer coverage as described in any one of the above terms, and includes the following steps:

S10: placing the outer casing: putting the closed end of the auxiliary tube into a water layer bottom, and pressing the auxiliary tube down hard to expel water and sludge; sleeving the outer casing outside the auxiliary tube, and pressing the outer casing down by external force to tightly secure the outer casing; and taking out the auxiliary tube;

S20: dredging by the outer casing and placing the outer casing to a suitable depth: putting the mud extractor in the outer casing, and rotating the handle to dig up and take out soil or thin mud until a dry soil layer is reached;

S30: placing the main tube and the encapsulated extraction electrode: placing the main tube in the outer casing, and placing the mud extractor adapted to the main tube to dig out a cylindrical pit under the outer casing; putting the encapsulated extraction electrode into the cylindrical pit, and taking out the main tube; and passing the lifting rod of the encapsulated extraction electrode through the top cover of the outer casing, and screwing the lifting rod tightly;

S40: providing another electrode and energizing: providing another encapsulated extraction electrode by repeating steps S10 to S30; subsequently, fixedly sleeving the two ferrules of the fixing ferrule assembly on two lifting rods, respectively, and tightening the threaded sleeves on the connecting rods to fix the power supply box; and connecting metal wires of the two encapsulated extraction electrodes to positive and negative electrodes of the power supply box, respectively;

and

S50: recovering the encapsulated extraction electrodes and obtaining a sample: raising the lifting rods to take out the encapsulated extraction electrodes when a preset energization time is reached; disassembling conventional electrodes to take out foam; and packing the foam in a plastic bag, and sending the foam as a sample to a laboratory for analysis.

Further, in step S20, the dry soil layer is a soil layer with obviously dry and loose soil particles.

Further, in step S10, the outer casing is pressed to stably stand in the dry soil layer.

Further, before placing the encapsulated extraction electrode, step S30 further includes performing the following preparations:

S31: fixing a conventional electrode to a lower electrical clip of the connector, and inserting a tip of the drip tube into the foam of the conventional electrode;

S32: connecting hoses to an extraction liquid container to feed a quantitative amount of extraction liquid into the liquid storage bottle; and

S33: sleeving the housing, and passing the hoses and the metal wire through a reserved hole of the housing.

The present disclosure has the following beneficial effects:
1. The present disclosure ensures the water-proof effect through three measures, namely providing the auxiliary tubes, providing the outer casings and increasing the excavation depth. As described in the operation steps, first, the auxiliary tube is provided to initially isolate water and sludge. Second, the outer casing is provided to initially waterproof, that is, to prevent most of the water from entering the outer casing. The outer casing can reach a large depth, and the water absorption of the soil ensures that the upper water and sludge cannot infiltrate quickly (at least not in a 24-hour extraction time). Third, a small pit is dug at the bottom to further avoid accidental water seepage. If the outer casing is loose, there may be a small amount of water seepage along the gap between the outer casing and the soil. To this end, the third measure is devised. In addition, in order to achieve the purpose of water insulation, waterproof and water-absorbing substances may also be filled between the outer casing and the main tube, for example, plastic sheeting is added first, and then soil is filled.
2. The present disclosure accomplishes electrode placement at a depth of 1-2 m. In the prior art, the electrode is generally buried at a depth of about 50 cm. Under special circumstances, the depth of the acceptable soil layer often reaches 1-2 m, or even more. The present disclosure can complete the burial work at a depth of 1-2 m, or even 3-4 m, and only needs to increase the length of the outer casing and the main tube.
3. The present disclosure improves the portability, operability and safety of the device through the encapsulated extraction electrodes. The encapsulated extraction electrode integrates the extraction liquid and the conventional electrode. It can be brought to the field after being made indoors, which is convenient to carry and reduces the time and workload of field operation.
4. The present disclosure only needs to dig a small pit (a small hole of 12 cm). Under the same burial depth, in the prior art, a large pit of 50 cm is needed, which requires 1-2 people to dig, making the prior art time-consuming and labor-intensive.

In addition, under the same conditions, the present disclosure simplifies the operation steps and reduces the influence of human operation. In the prior art, the electrode burying operation includes 6 steps, including digging the pit, burying the electrode, filling soil, feeding the extraction liquid, compacting the soil and connecting the power supply. The present disclosure only requires 3 steps, including digging the pit, burying the electrode and connecting the power supply. The method of the present disclosure is simple to operate, and reduces the disturbance to the soil and the non-uniformity of the artificial feeding of the extraction liquid. Meanwhile, the extraction liquid is concentrated inside the conventional electrode and diffuses from the inside to the outside, which ensures the energization effect and the extraction effect.
5. In the present disclosure, to feed the extraction liquid, it is only necessary to connect the hoses to the interface of the storage container and open the valve. This greatly reduces the opportunity for the operator to come into contact with acid and improves operational safety.

### BRIEF DESCRIPTION OF THE DRAWINGS

FIG. 1 is an overall structural diagram of an auxiliary tube;

FIG. 2 is an overall structural diagram of an outer casing;

FIG. 3 is a structural diagram of a main tube;

FIG. 4 is an overall structural diagram of a mud extractor;

FIG. 5 is a structural diagram of a dredging wheel;

FIG. 6 is a structural diagram of a first bottom plate (a second bottom plate);

FIG. 7 is an overall structural diagram of an encapsulated extraction electrode;

FIG. 8 is a structural diagram of a housing;

FIG. 9 is a structural diagram of a tray;

FIG. 10 is a structural diagram of a lifting rod;

FIG. 11 is an overall structural diagram of a fixing ferrule assembly;

FIG. 12 is a schematic diagram of placing the outer casing;

FIG. 13 is a schematic diagram of dredging by the outer casing and placing the outer casing to a suitable depth;

FIG. 14 is a schematic diagram of placing the main tube and the encapsulated extraction electrode; and

FIG. 15 is a schematic diagram of providing another electrode and energizing.

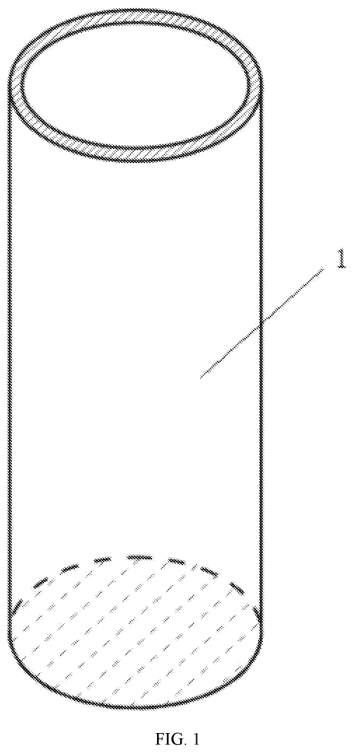

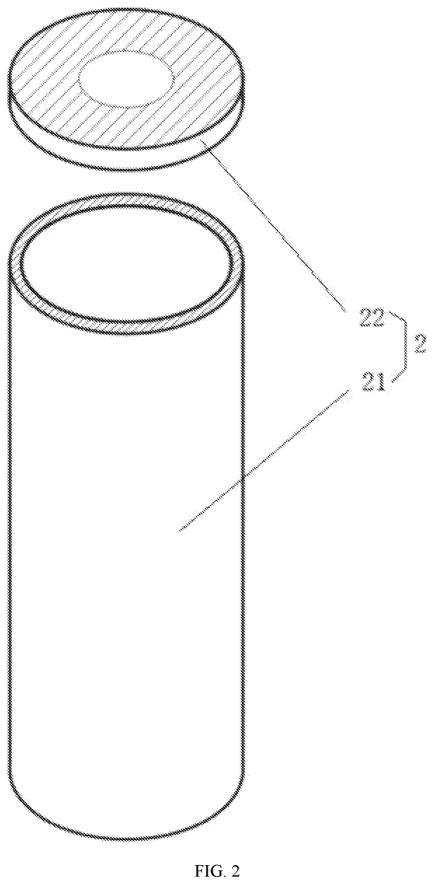

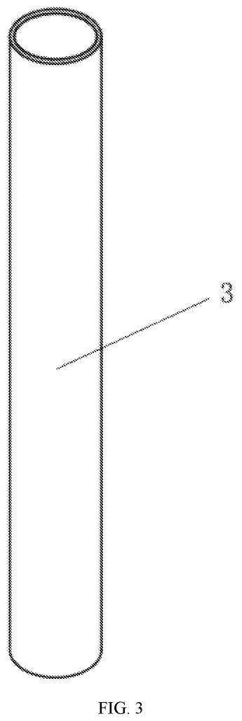

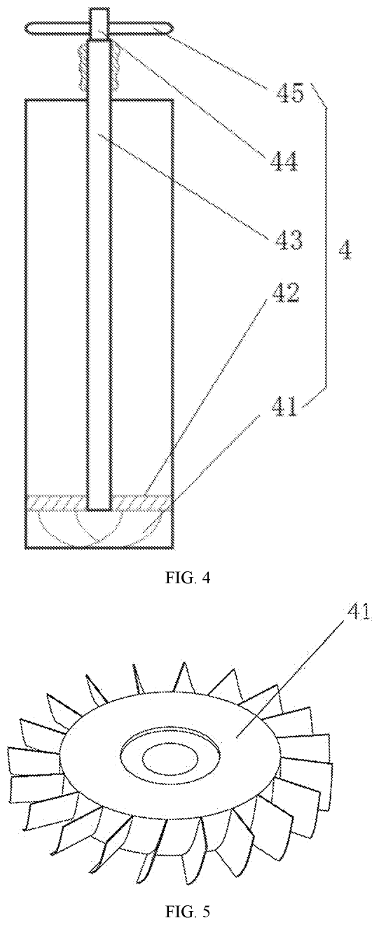

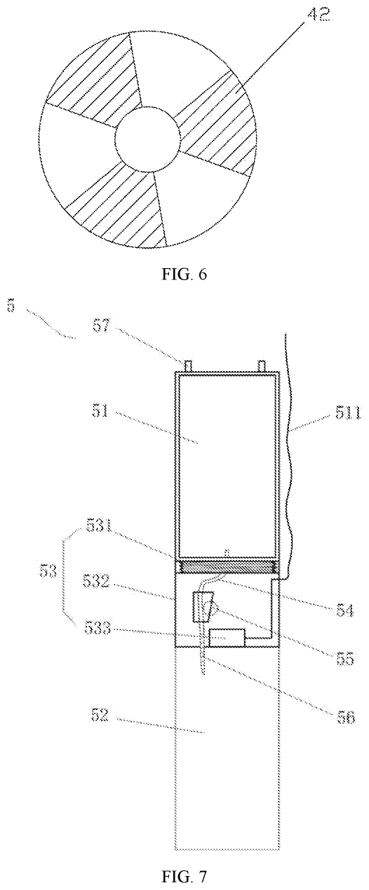

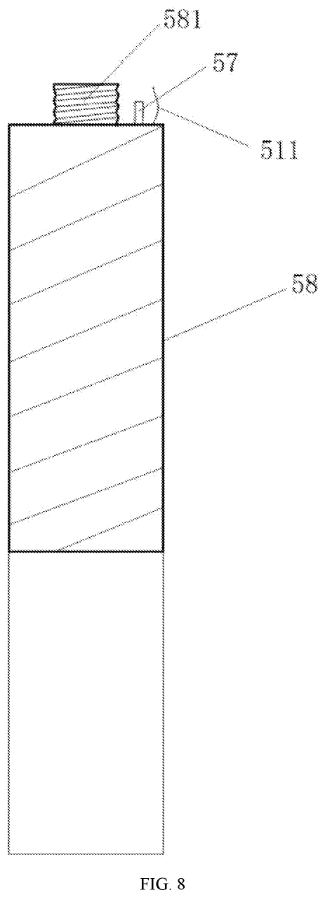

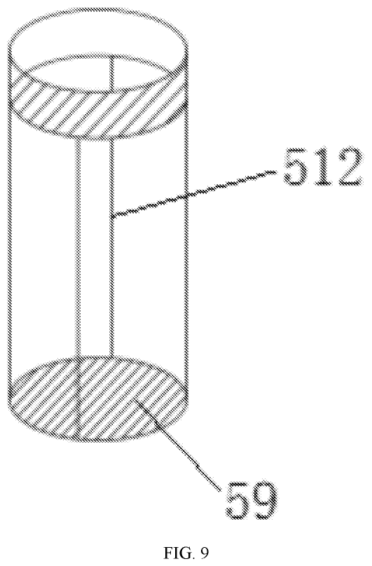

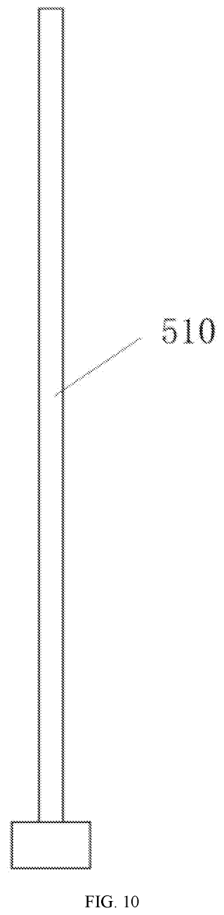

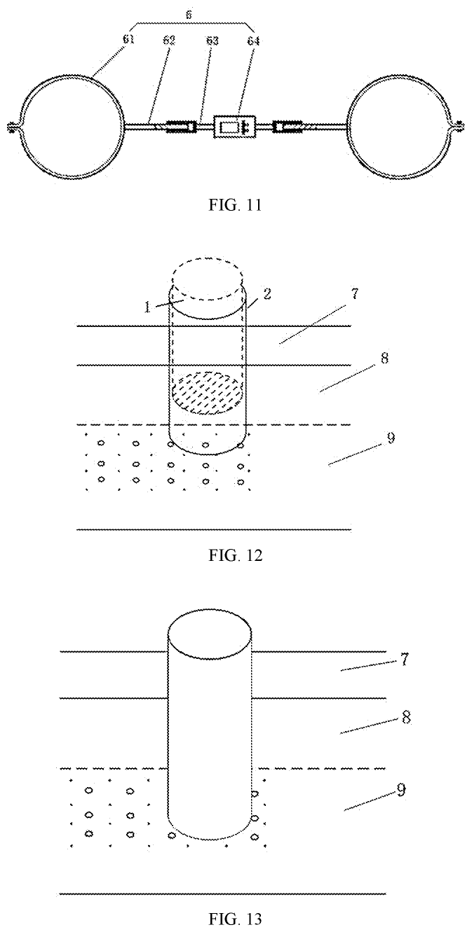

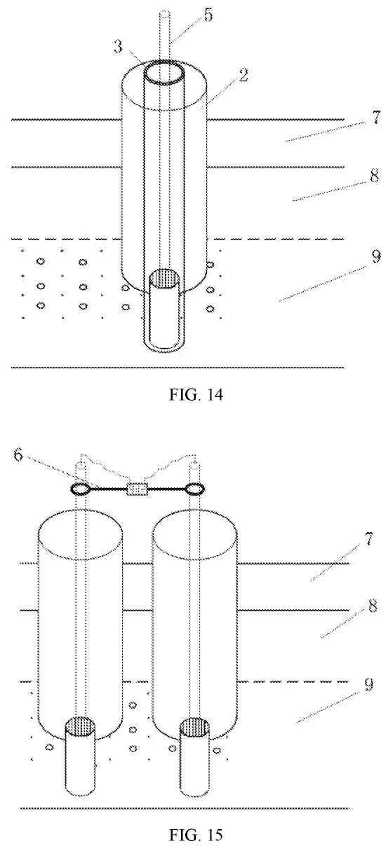

Reference Numerals: 1. auxiliary tube; 2. outer casing; 21. casing body; 22. top cover; 3. main tube; 4. mud extractor; 41. dredging wheel; 42. bottom plate; 43. outer rod; 44. inner rod; 45. handle; 5. encapsulated extraction electrode; 51. liquid storage bottle; 52. conventional electrode; 53. connector; 531. second screw; 532. shell; 533. electrical clip; 54. drip tube; 55. valve; 56. plug; 57. hose; 58. housing; 581. first screw; 59. tray; 510. lifting rod; 511. metal wire; 512. post; 6. fixing ferrule assembly; 61. ferrule; 62. connecting rod; 63. threaded sleeve; 64. power supply box; 7. water layer; 8. water-rich soil layer; and 9. dry soil layer.

### DETAILED DESCRIPTION OF THE EMBODIMENTS

### Embodiment 1

A device for geo-electric extraction under water layer coverage includes auxiliary tubes 1, outer casings 2, main tubes 3, mud extractors 4, encapsulated extraction electrodes 5 and a fixing ferrule assembly 6.

The auxiliary tubes 1 each have one end open and the other end closed. In this embodiment, the auxiliary tubes 1 each are made of a plastic material, with a diameter of 15 cm and a length of 1 m. The auxiliary tubes 1 are designed to preliminarily expel sludge with much water at a bottom, so as to ensure that when the outer casing 2 is used, there will not be too much water or sludge in the outer casing 2. If the length is not enough, another auxiliary tube 1 may be added.

The outer casings 2 each have one end open and the other end detachably connected to a top cover 22. The top cover 22 is provided with a central hole. An inner diameter of a casing body 21 of the outer casing 2 is larger than an outer diameter of each of the auxiliary tubes 1. In this embodiment, the outer casing 2 is a steel tube, and a diameter of the casing body 21 of the outer casing 2 is similar to that of the auxiliary tube 1 (slightly larger than 15 cm). The diameter of the casing body of the outer casing is exactly suitable for the outer casing to sleeve the auxiliary tube 1, and each outer casing has a length of 1 m. The outer casing 2 is configured to initially isolate water from around the device for geo-electric extraction. If the length is not enough, another outer casing 2 may be added.

The top cover 22 of the outer casing 2 provided with a central hole, which is configured to sleeve and fix a lifting rod 510. The outer casing 2 is matched with the mud extractor 4. The outer casing and the mud extractor have the same diameter, and the mud extractor 4 is configured to dig soil.

An outer diameter of each of the main tubes 3 is smaller than the inner diameter of each of the outer casings 2. In this embodiment, the main tube 3 is a steel tube with two ends open, with a diameter of 5 cm and a length of 1.5 m. The main tube 3 is configured to dig soil, drill downward and bury the extraction electrode. In this embodiment, the mud extractor 4 is matched with the main tube 3. The main tube and the mud extractor have the same diameter, and the mud extractor 4 is configured to dig soil.

The mud extractors 4 each include an inner rod 44, an outer rod 43 and a bottom plate 42. The outer rod 43 is sleeved outside the inner rod 44. The inner rod 44 has one end provided with a dredging wheel 41 and the other end provided with a handle 45. The bottom plate 42 includes a first bottom plate and a second bottom plate that are arranged up and down. The first bottom plate and the second bottom plate are correspondingly provided with a plurality of mud holes, and the rest parts of the first bottom plate and the second bottom plate are used as mudguards. When the first bottom plate and the second bottom plate are overlapped, the mudguards cover the mud holes. The first bottom plate and the second bottom plate are arranged adjacent to one end of the dredging wheel 41. The first bottom plate is fixedly connected to the outer rod 43, and the second bottom plate is fixedly connected to the inner rod 44. The outer contours of the dredging wheel 41, the first bottom plate and the second bottom plate are adapted to the inner diameter of the main tube 3 or the outer casing 2.

In this embodiment, the first bottom plate and the second bottom plate are circular, and each are provided with three fan-shaped mud holes that are evenly distributed. Generatrices of the fan-shaped mud holes are radiated outward from a circular center.

In this embodiment, when the digging operation is performed, the outer rod is rotated such that the first bottom plate and the second bottom plate are completely overlapped, and the orifices of the fan-shaped mud holes communicate with each other. When the soil lifting operation is performed, the outer rod is rotated such that the first bottom plate and the second bottom plate stagger each other, and the orifices of the fan-shaped mud holes are shielded from each other. In this way, the mud extractor 4 is pulled up to a tube orifice to take out the mud.

In this embodiment, the dredging wheel 41 is a turbine fan blade.

The encapsulated extraction electrodes 5 each include a housing 58. The housing 58 includes an upper part and a lower part. The upper part of the housing is a closed structure, and the lower part of the housing is an open structure. A bottom end of the lower part of the housing is provided with a tray 59, and the tray 59 is connected to the upper part of the housing through posts 512.

A liquid storage bottle 51 for storing an extraction liquid is provided in the upper part of the housing. A conventional electrode 52 is provided between the tray 59 and the upper part of the housing. A drip tube 54 with a valve 55 is provided between the liquid storage bottle 51 and the conventional electrode 52. The drip tube 54 delivers the extraction liquid in the liquid storage bottle 51 to the conventional electrode 52. A lifting rod 510 is provided on an upper surface of the housing 58.

In this embodiment, the conventional electrode 52 is the electrode described in the patent ZL200720125708, the structure of which is not changed.

The liquid storage bottle 51 is configured to store the extraction liquid, which is generally a HNO₃ solution with a specific concentration (it may also be changed to other components as required).

The bottom of the liquid storage bottle 51 is provided with the drip tube 54 with a valve, which is configured to deliver the extraction liquid in the liquid storage bottle 51 to the conventional electrode 52. The drip tube 54 is composed of a plastic hose provided with a tipped plug 56. The plug 56 is made of a hard plastic material and can be inserted into foam of the conventional electrode. The valve is made of a plastic material. The drip tube adopts the same drip irrigation principle as a medical infusion tube, and controls the flow of the liquid by pushing a roller.

A top of the liquid storage bottle 51 is provided with two hoses 57, through which the extraction liquid can be connected and fed indoors. In addition, after the electrode is provided in the field, the hoses are configured to communicate with the atmosphere, so as to maintain a pressure difference between the top and the bottom of the liquid storage bottle 51, such that the liquid flows out of the drip tube 54 smoothly. To feed the extraction liquid, it is necessary to ensure that one hose is connected to the atmosphere. During transport, it is necessary to keep the two hoses clamped to prevent the liquid from escaping.

The liquid storage bottle 51 and the conventional electrode 52 are fixedly connected together through a connector 53. The connector 53 has a cylindrical plastic shell 532. A bottom part of the shell 532 is closed, and an upper part thereof is provided with an opening. The upper opening is internally provided with a thread. The shell can be sleeved on the bottom of the liquid storage bottle 51 and connected to the liquid storage bottle 51 by the thread. A bottom of the connector 53 is provided with an electrical clip 533 for fixing the conventional electrode, and the electrical clip specifically holds a carbon rod in the conventional electrode 52.

In this embodiment, a metal wire 511 drawn from the electrical clip 533 is drawn out of the connector 53 to be connected to a power supply. An upper end of the connector 53 fixes the liquid storage bottle 51 through a second screw 531.

In this embodiment, the housing 58 is cylindrical, and the housing 58 can accommodate the conventional electrode 52, the connector 53, the liquid storage bottle 51 and other devices. It is mainly designed to place and recover the encapsulated extraction electrode.

In this embodiment, the housing 58 is divided into an upper part and a lower part. The upper part of the housing is a closed plastic structure, and the lower part of the housing is an open structure. The tray 59 provided at the bottom end of the lower part of the housing is circular, and the tray 59 is connected to the upper part of the housing by four thin posts 512. The top of the housing 58 is provided with a reserved hole for passing the hoses 57 and the metal wire 511. First, the upper part of the housing 58 is sleeved outside the liquid storage bottle 51 and the connector 53, and the hoses 57 and the metal wire 511 are passed through the reserved hole. Then, the lower part of the housing 58 is sleeved outside the conventional electrode 52, and a screw between the upper part and the lower part of the housing is tightened.

An upper surface of the closed end of the housing 58 is provided with a first screw 581, and the first screw 581 is matched with the lifting rod 510 for lifting and lowering the housing 58.

The fixing ferrule assembly 6 includes a power supply box 64 and two ferrules 61. The two ferrules 61 are respectively provided at two ends of the power supply box 64. The ferrules 61 each are connected to the power supply box 64 at an adjustable distance, and the ferrules 61 each are matched with a lifting rod 510.

A connecting rod 62 and a threaded sleeve 63 are arranged between each of the ferrules 61 and the power supply box 64. One end of the threaded sleeve 63 is fixedly connected to the power supply box 64, and the other end thereof is threadedly connected to one end of the connecting rod 62. The other end of the connecting rod 62 is fixedly connected to each of the ferrules 61.

The power supply box 64 is provided therein with a battery and a battery clip for connecting the metal wire 511. The connecting rod 62 and the threaded sleeve 63 (with an internal thread) are provided outside the power supply box 64. The threaded sleeve 63 is tightened to connect the ferrule 61 and fix the power supply box 64. The ferrule 61 is ring-shaped and can be sleeved on the lifting rod 510. One end of the ferrule is provided with a screw, and the ferrule can be firmly fixed to the lifting rod 510 by tightening the screw. The connecting rod 62 is provided at the other end of the ferrule 61, which is provided with a thread at an end to connect the threaded sleeve 63.

When in use, first, the left and right ferrules 61 are sleeved on the lifting rods 510, and the screws are tightened to fix the ferrules. Then, the threaded sleeves 63 connecting the power supply box 64 are connected to one end of the connecting rods 62 and tightened. The distance between the two ferrules 61 is controlled by adjusting the tightness of a nut.

### Embodiment 2

A method for geo-electric extraction under water layer coverage uses the device for geo-electric extraction under water layer coverage provided in Embodiment 1, and includes the following steps:

S10: Place the outer casing 2: Put the closed end of the auxiliary tube 1 into a water layer bottom, and press the auxiliary tube down hard to expel water and sludge; sleeve the outer casing 2 outside the auxiliary tube 1, and press the outer casing 2 down by external force to tightly secure the outer casing; and take out the auxiliary tube 1.

S20: Dredge by the outer casing 2 and place the outer casing to a suitable depth: Put the mud extractor 4 in the outer casing 2, and rotate the handle 45 to dig up and take out soil or thin mud and until a dry soil layer 9 is reached. If a water-rich soil layer 8 is thick, the mud extractor can be operated repeatedly until the dry soil layer 9 is reached.

The dry soil layer 9 is a soil layer with obviously dry and loose soil particles.

In Step S20 and Step S10, the outer casing 2 is pressed to stably stand in the dry soil layer 9.

S30: Place the main tube 3 and the encapsulated extraction electrode: Place the main tube 3 in the outer casing 2, and place the mud extractor 4 adapted to the main tube 3 to dig out a cylindrical pit under the outer casing 2; put the encapsulated extraction electrode 5 into the cylindrical pit, and take out the main tube 3; and pass the lifting rod 510 of the encapsulated extraction electrode 5 through the top cover 22 of the outer casing 2, and screw the lifting rod tightly.

Before placing the encapsulated extraction electrode, the following preparations are required:

S31: Fix a conventional electrode 52 to a lower electrical clip 533 of the connector 53, and insert a tip of the drip tube 54 into foam of the conventional electrode 52.

S32: Connect hoses 57 to an extraction liquid container to feed a quantitative amount of extraction liquid into the liquid storage bottle 51.

S33: Sleeve the housing 58, and pass the hoses 57 and a metal wire 511 through a reserved hole at a top of the housing 58.

S40: Provide another electrode and energize: Provide another encapsulated extraction electrode 5 by repeating Steps S10 to S30; subsequently, fixedly sleeve the two ferrules 61 of the fixing ferrule assembly 6 on two lifting rods 510, respectively, and tighten the threaded sleeves 63 on the connecting rods 62 to fix the power supply box 64; and connect metal wires 511 of the two encapsulated extraction electrodes to positive and negative electrodes of the power supply box 64, respectively.

S50: Recover the encapsulated extraction electrodes and obtain a sample: raise the lifting rods 510 to take out the encapsulated extraction electrodes when a preset energization time is reached; disassemble conventional electrodes 52 to take out foam; and pack the foam in a plastic bag, and send the foam as a sample to a laboratory for analysis.

The above described are merely preferred embodiments of the present disclosure and are not intended to limit the present disclosure in any form. Any minor changes, equivalent variations and modifications made to the above embodiments based on the technical essence of the present disclosure should fall within the scope defined by the technical solutions of the present disclosure.

What is claimed is:

1. A device for geo-electric extraction under water layer coverage, comprising auxiliary tubes, outer casings, main tubes, mud extractors, encapsulated extraction electrodes and a fixing ferrule assembly, wherein
the auxiliary tubes each comprise a first end open and a second end closed;
the outer casings each comprise a first end open, and a second end detachably connected to a top cover provided with a central hole; and an inner diameter of each of the outer casings is larger than an outer diameter of each of the auxiliary tubes;
an outer diameter of each of the main tubes is smaller than the inner diameter of each of the outer casings;
the mud extractors each comprise an inner rod, an outer rod and a bottom plate; wherein
the outer rod is rotatably sleeved outside the inner rod;
the inner rod comprises one a first end provided with a dredging wheel and a second end provided with a handle;
the bottom plate comprises a first bottom plate and a second bottom plate, wherein the first bottom plate and the second bottom plate are arranged up and down;
the first bottom plate and the second bottom plate each are provided with a plurality of mud holes, and the plurality of mud holes of the first bottom plate are staggered with the plurality of mud holes of the second bottom plate;
the first bottom plate and the second bottom plate are fitted and arranged adjacent to one end of the dredging wheel;
the first bottom plate is fixedly connected to the outer rod, and the second bottom plate is fixedly connected to the inner rod; and
a diameter of the dredging wheel, a diameter of the first bottom plate and a diameter of the second bottom plate are adapted to the inner diameter of each of the outer casings;
the encapsulated extraction electrodes each comprise a housing; the housing comprises an upper part and a lower part; the upper part of the housing is a closed structure, and the lower part of the housing is an open structure; a bottom end of the lower part of the housing is provided with a tray; and the tray is connected to the upper part of the housing through posts;
a liquid storage bottle for storing an extraction liquid is provided in the upper part of the housing; a conventional electrode is provided between the tray and the upper part of the housing; a drip tube with a valve is provided between the liquid storage bottle and the conventional electrode; and the drip tube delivers the extraction liquid in the liquid storage bottle to the conventional electrode; and
the fixing ferrule assembly comprises a power supply box and two ferrules; the two ferrules are respectively provided at two ends of the power supply box; the two ferrules each are connected to the power supply box at an adjustable distance; and the two ferrules each are matched with a lifting rod.

2. The device according to claim 1, wherein the first bottom plate and the second bottom plate are circular, and each of the first bottom plate and the second bottom plate is provided with three fan-shaped mud holes, the three fan-shaped mud holes are evenly distributed; and generatrices of the three fan-shaped mud holes are radiated outward from a circular center.

3. The device according to claim 1, wherein an upper surface of the housing is provided with a first screw, the first screw is matched with the lifting rod for lifting and lowering the housing.

4. The device according to claim 3, wherein the liquid storage bottle and the conventional electrode are fixedly connected together through a connector; the connector comprises a shell; a first end of the shell is provided with an opening, the opening is provided therein with a second screw for fixing the liquid storage bottle; a second end of the shell is provided with a closing bottom plate; the closing bottom plate is provided with an electrical clip configured for fixing the conventional electrode; and the electrical clip holds a carbon rod in the conventional electrode.

5. The device according to claim 1, wherein a connecting rod and a threaded sleeve are arranged between each of the two ferrules and the power supply box; a first end of the threaded sleeve is fixedly connected to the power supply box, and a second end of the threaded sleeve is threadedly connected to a first end of the connecting rod; and a second end of the connecting rod is fixedly connected to each of the two ferrules.

6. A method for geo-electric extraction under water layer coverage, using the device according to claim 1, and comprising the following steps:
S10: placing the outer casing: putting a closed end of the auxiliary tube into a water layer bottom, and pressing the auxiliary tube down hard to expel a water and a sludge; sleeving the outer casing outside the auxiliary tube, and pressing the outer casing down by an external force to tightly secure the outer casing; and taking out the auxiliary tube;
S20: dredging by the outer casing and placing the outer casing to a predetermined depth: putting the mud extractor in the outer casing, and rotating the handle to dig up and take out a soil or a thin mud until a dry soil layer is reached;
S30: placing the main tube and a first encapsulated extraction electrode of the encapsulated extraction electrodes: placing the main tube in the outer casing, and placing the mud extractor adapted to the main tube to dig out a cylindrical pit under the outer casing; putting the first encapsulated extraction electrode into the cylindrical pit, and taking out the main tube; and passing the lifting rod of the first encapsulated extraction electrode through the top cover of the outer casing, and screwing the lifting rod tightly;
S40: providing a second encapsulated extraction electrode of the encapsulated extraction electrodes and energizing: providing the second encapsulated extraction electrode by repeating steps S10 to S30; subsequently, fixedly sleeving the two ferrules of the fixing ferrule assembly on two lifting rods, respectively, and tightening threaded sleeves on connecting rods to fix the power supply box; and connecting metal wires of the first and second encapsulated extraction electrodes to positive and negative electrodes of the power supply box, respectively; and
S50: recovering the first and second encapsulated extraction electrodes and obtaining a sample: raising the two lifting rods to take out the first and second encapsulated extraction electrodes when a preset energization time is reached; disassembling the conventional electrode to take out a foam; and packing the foam in a plastic bag, and sending the foam as the sample to a laboratory for an analysis.

7. The method according to claim 6, wherein in step S20, the dry soil layer is a soil layer with obviously dry and loose soil particles.

8. The method according to claim 7, wherein in step S10, the outer casing is pressed to stably stand in the dry soil layer.

9. The method according to claim 6, wherein before placing the first encapsulated extraction electrode, step S30 further comprises performing the following preparations:
S31: fixing the conventional electrode to a lower electrical clip of the connector, and inserting a tip of the drip tube into the foam of the conventional electrode;
S32: connecting hoses to an extraction liquid container to feed a predetermined amount of extraction liquid into the liquid storage bottle; and
S33: sleeving the housing, and passing the hoses and the metal wire of the first encapsulated extraction electrode through a reserved hole of the housing.

10. The method according to claim 6, wherein the device, wherein the first bottom plate and the second bottom plate are circular, and each of the first bottom plate and the second bottom plate is provided with three fan-shaped mud holes, the three fan-shaped mud holes are evenly distributed; and generatrices of the three fan-shaped mud holes are radiated outward from a circular center.

11. The method according to claim 6, wherein the device, wherein an upper surface of the housing is provided with a first screw, the first screw is matched with the lifting rod for lifting and lowering the housing.

12. The method according to claim 11, wherein the device, wherein the liquid storage bottle and the conventional electrode are fixedly connected together through a connector; the connector comprises a shell; a first end of the shell is provided with an opening, the opening is provided therein with a second screw for fixing the liquid storage bottle; a second end of the shell is provided with a closing bottom plate; the closing bottom plate is provided with an electrical clip fixing the conventional electrode; and the electrical clip holds a carbon rod in the conventional electrode.

13. The method according to claim 6, wherein the device, wherein a connecting rod and a threaded sleeve are arranged between each of the two ferrules and the power supply box; a first end of the threaded sleeve is fixedly connected to the power supply box, and a second end of the threaded sleeve is threadedly connected to a first end of the connecting rod; and a second end of the connecting rod is fixedly connected to each of the two ferrules.
